(19) United States
(12) Patent Application Publication
(10) Pub. No.: US 2026/0278101 A1
(43) Pub. Date: Sep. 17, 2026

(54) CODE SEGMENT VALIDATION

(71) Applicant: Intel Products IP LLC, Santa Clara, CA (US)

(72) Inventor: Deepak MOHAN, Hillsboro, OR (US)

(21) Appl. No.: 19/667,383

(22) Filed: May 4, 2026

Related U.S. Application Data
(60) Provisional application No. 63/952,240, filed on Dec. 31, 2025.

(51) Int. Cl. G06F 21/56; G06F 13/28; G06F 21/60

(52) U.S. Cl. CPC G06F 21/566; G06F 13/28; G06F 21/602

(57) ABSTRACT

Examples described herein relate to a network interface device. The network interface device includes a host interface; a network interface; a direct memory access (DMA) circuitry; and a circuitry. In some examples, the circuitry is to: receive a packet comprising code segments and permit execution of the code segments by a processor of a host system based on complexity of the code segments or deny execution of the code segments by the processor of the host system based on the complexity of the code segments.

### RELATED APPLICATION

This application claims the benefit of priority to U.S. Provisional Application 63/952,240, filed Dec. 31, 2025. The entire contents of that application are incorporated by reference.

### BACKGROUND

Data centers provide vast processing, storage, and networking resources to client devices. For example, client devices can leverage data centers to perform image processing, artificial intelligence-based inference models, computation, data storage, and data retrieval. Client devices access resources of a data center using a wired or wireless networking connection. Edge network devices perform computing tasks proximate to the client devices to reduce latency of data processing.

### BRIEF DESCRIPTION OF THE DRAWINGS

FIG. 1 depicts an example system.

FIG. 2 shows an example operation of a system.

FIG. 3 depicts an example process.

FIGS. 4A and 4B depict example network interface devices.

FIG. 5 depicts an example network interface device.

FIG. 6 depicts an example system.

### DETAILED DESCRIPTION

Data center, Edge, and client devices receive processes to execute as well as firmware updates and other software updates. However, a malicious actor can cause invocations that trigger cold starts on the host system processor and consume processor resources. For example, to verify if a transaction or code snippet is valid or malicious (e.g., an infinite loop or logic bomb), the host system processor can execute the code. However, execution of the code creates a halting gap vulnerability and malicious actors can flood the host system with resource-intensive requests, forcing the host system processor to waste power and cycles processing invalid work and can amount to a Denial of Service (DoS) attack. Utilization of such processor resources can increase total cost of ownership (TCO) of the processor because the processor is not being utilized to perform operations for clients.

As described herein, a host system can offload validation of code received in a packet to a programmable network interface device. The code can include invocation code, which can call for execution of a second process, or other executable code. The second process can be received with the invocation code, received after the invocation code, or received before the invocation code. Instead of executing the invocation code or permitting the host system to execute the invocation code, the network interface device can determine whether to execute the received code based on a complexity level of the code. In some examples, the complexity level of the code can indicate whether the code is likely a malicious code that is likely to waste resources of the host processor. For example, to determine complexity level of the code, the network interface device can determine an Abstract Syntax Tree (AST) that represents the code and calculate a deterministic complexity score based on a topology of the code (e.g., a level of nesting or branching of the code). The network interface device can determine the complexity level by parsing the code segment into an AST without executing the code segment, and can compute the complexity level in a single O(N) traversal of the AST, where N is the size of the code segment. A code complexity exceeding a complexity level threshold can be dropped by the network interface device, and not interrupt the host system processor. Various examples provide Edge nodes with protection from computational DoS attacks by filtering logic bombs at a network interface device ingress point and allow utilization of the host processor for valid, high-value workloads.

Various examples can apply to distributed Edge functions as well as other environments. Examples can be used in a Decentralized Physical Infrastructure (DePIN) to protect shared hardware assets (e.g., electric vehicle (EV) chargers, cellular micro-cells, or others) from malicious exhaustion attacks. Examples can be used in autonomous swarms for enabling low-power drones or robotic fleets to validate coordination messages without engaging their main control central processing units (CPUs). Examples can be used in high-density multi-tenant function as a service (FaaS) systems for offloading security for serverless cloud environments where untrusted functions compete for resources on a single host.

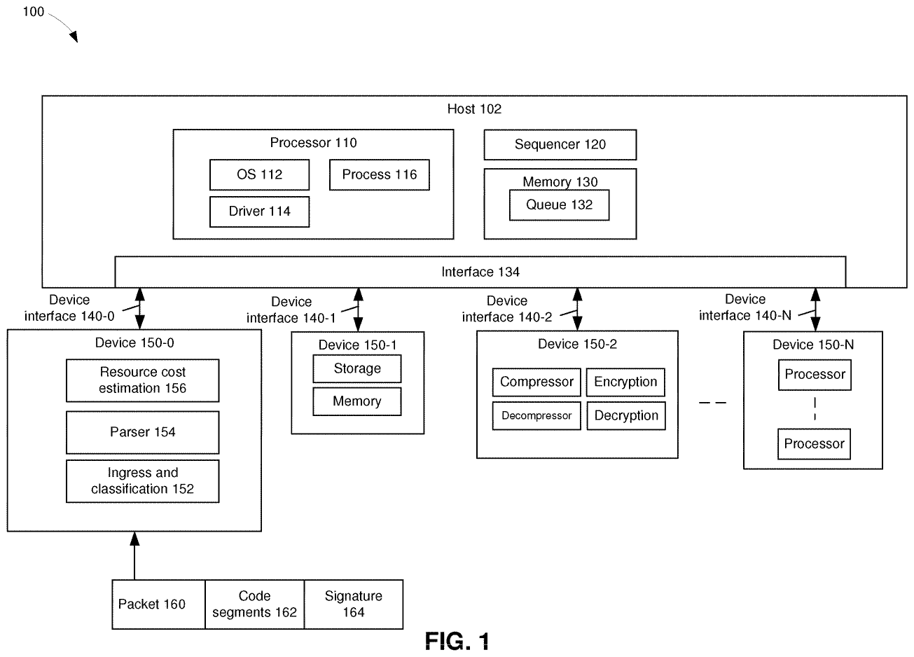

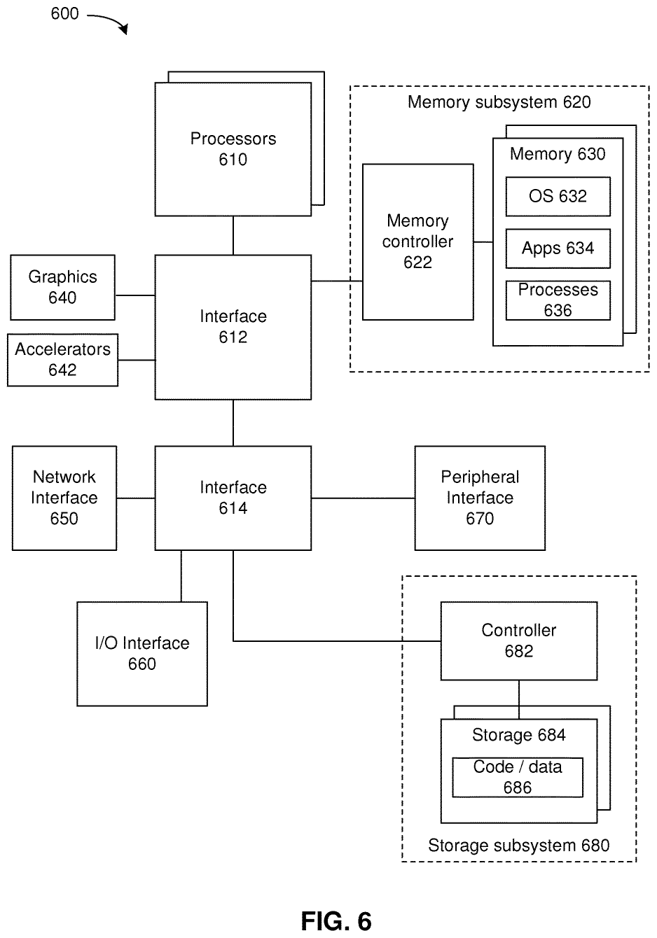

FIG. 1 depicts an example system. Host system 102 can include one or more processors 110, memory 130, and other circuitry and software described at least with respect to FIG. 6. Processors 110 can execute at least one or more of: operating system (OS) 112, driver 114, processes 116, and other software. Driver 114 can provide a communication interface between OS 112 and one or more devices 150-0 to 150-N, where N is an integer. Processes 116 can include one or more of: an application, process, thread, a virtual machine (VM), microVM, container, microservice, virtual function (VF), virtual device, or other virtualized execution environment.

Processor 110 can access one or more of devices 150-0 to 150-N using interface 134 and device interfaces 140-0 to 140-N consistent at least with Peripheral Component Interconnect express (PCIe), Compute Express Link (CXL), or other standards. The PCIe protocol is described in Peripheral Component Interconnect (PCI) Express Base Specification 1.0 (2002), as well as earlier versions, later versions, and variations thereof. The CXL protocol is described in Compute Express Link Specification version 1.0 (2019), as well as earlier versions, later versions, and variations thereof). Processor 110 can access one or more of devices 150-0 to 150-N as Single Root I/O Virtualization (SR-IOV) virtual functions (VFs) or Scalable I/O Virtualization (SIOV) Assignable Device Interfaces (ADIs).

One or more of devices 150-0 to 150-N can include one or more: accelerator, graphics processing unit (GPU), storage device, network interface device, or other circuitry. For example, an accelerator can perform cryptographic, compression, or decompression operations on data. Devices 150-0 to 150-N can include one or more hardware platforms that include at least: a host interface board (e.g., instance of PCIe switches), cluster of processors (e.g., cores, GPUs, accelerators, or other circuitry), switch boards (e.g., network interface devices, Ethernet or NVLink network switches, or virtual network switches), or others.

In some examples, device 150-0 can include a network interface device. Network device can include forwarding element, network interface device, or other devices. In some examples, a network interface device can refer to one or more of: a network interface controller (NIC), a remote direct memory access (RDMA)-enabled NIC, SmartNIC, router, switch, infrastructure processing unit (IPU), data processing unit (DPU), or network-attached appliance.

Ingress and classification circuitry 152 can identify received packet 160 that includes executable code segments 162. Executable code segments 162 can include includes at least: a WebAssembly (WASM) module, a serverless function definition, a programmable logic controller (PLC) update, a third-party plugin or extension, executable binary, bytecode representation of executable logic, or other software. Ingress and classification circuitry 152 can direct packets with executable payloads 162 to parser circuitry 154 (e.g., compute complex or other circuitry) rather than for processing by host processor-executed operating system (OS) 112. Ingress and classification circuitry 152 can direct packets without executable payloads 162 for processing by OS 112.

In some examples, parser circuitry 154 can be configured with a trust bypass path to route a payload of packet 160 carrying a valid cryptographic signature 164 (e.g., Root Authority Signature) or other value from an allowlisted authority to queue 132, and bypass complexity analysis and resource cost estimation. Allowlisted authority public keys can be stored in hardware-rooted immutable read-only memory (ROM) accessible to device 150-0, so that the allowlist cannot be modified by OS 112 or firmware. A signed firmware update from the ROM-trusted authority can update the allowlist. Bypass applies to the cryptographically signed payload 162, and device 150-0 can automatically revert to structural analysis and resource cost estimation for payloads of subsequent packets, preventing time-of-check to time-of-use (TOCTOU) exploitation.

In some examples, to validate code segment 162, parser circuitry 154 may not execute executable code segments 162 but can decompile bytecodes of executable code segments 162 into a tree structure (e.g., Abstract Syntax Tree (AST)) for analysis of computational complexity. An Abstract Syntax Tree (AST) can hierarchically organize actions, numbers, and names. Parsing can incur a single depth-first traversal at O(N) cost, with no backtracking and no re-evaluation of a node.

Resource cost and estimation 156 can calculate a resource score of cost of execution of code segments 162, or resource cost vector, based on the AST topology. Translation of AST structural topology into a resource cost vector can be expressed in hardware-native units (e.g., CPU cycles, power usage, memory utilization, memory bandwidth utilization, or others). For example, the resource cost vector can indicate at least one or more of: (i) estimated CPU cycles (C_cycles) to execute code segments 162 on host processor 110; (ii) estimated power consumption to execute code segments 162 (C_power); and/or (iii) estimated memory utilization to execute code segments 162 (C_memory).

Estimated CPU cycles can be computed as follows:

C_cycles=(α·χ·C_branch)+(β·δ\hat{ }γ·C_recurse), where:
α and β are policy weighting coefficients,
α represents a programmable policy weighting coefficient on the cyclomatic-complexity (χ) term, stored in a hardware register and updatable via microcode/firmware,
β represents a programmable policy weighting coefficient on the recursion-depth (δ) term, stored in a hardware register and updatable via microcode/firmware. Together α and β let the operator bias the gate toward branching-sensitive or recursion-sensitive workloads without a silicon change,
χ is the cyclomatic complexity of the payload AST,
δ is the maximum recursion depth,
C_branch and C_recurse are programmable hardware constants stored in device registers and calibrated to the target host processor architecture, and
γ represents a recursion penalty exponent and can be set to capture superlinear cost growth under deep nesting.

Variables α, β, χ, δ, C_branch, and C_recurse can be stored in programmable hardware registers and can be updated via microcode patch or firmware update, enabling recalibration to different target host processor architectures.

In some examples, parser circuitry 154 can permit or deny execution of code segments 162 based on a density-based comparison of cost density (resource cost per byte) versus effective budget (budget per byte) to identify payloads that are resource intensive relative to their size. An effective budget can be determined as follows:
B_effective=B_base/δ\hat{ }γ (when δ>0)
B_effective=B_base (when δ=0, no recursion), where
B_base can be set as a programmable base budget expressed in CPU cycles per byte of payload, stored in a hardware register on the device and calibrated to the target host architecture.

Cost density can be determined as C_cycles/N, where N is the payload size in bytes. For example, parser circuitry 154 can permit execution of code segments 162 based on cost density being less than or equal to B_effective or reject execution of code segments 162 based on cost density being greater than B_effective. For example, code segments 162 that are smaller in size but include an infinite loop can have a cost density greater than B_effective and parser circuitry 154 can reject execution of such code segments.

In some examples, cost of execution of code segments 162 can be based on a complexity score or number of nested nodes of the tree structure: Omega=α*Chi+β*Delta, where Chi represents Cyclomatic Complexity (branching) and Delta represents Recursion Depth (nesting). Cyclomatic complexity counts the number of linearly independent paths through the control flow graph. To determine complexity of execution of code segments 162, during the AST traversal, counters can be maintained for cyclomatic complexity (χ) and recursion depth (δ). A higher complexity operation is likely to indicate the code is malicious or part of a Computational Denial of Service (cDoS) attack, and parser 154 can deny execution of such payload and drop the associated packet even if there are enough resources to execute the code.

In some examples, the AST can represent a tree of nodes of one or more types. A node type can correspond to a level of complexity. Complexity can be associated with a number of detected node types. Examples of node types can be as follows.

| Node Type | Source Construct | Example description |
|---|---|---|
| LOOP_NODE | while, for, loop | Triggers exit reachability |
| | | analysis |
| BRANCH_NODE | if, switch, br_if | Increments χ (cyclomatic |
| | (branches to a loop, | complexity count) |
| | a block, or an if | |
| | statement, based on | |
| | a boolean (0 or 1) | |
| | condition) | |
| SWITCH_NODE | Directs workflow | Increment χ (cyclomatic |
| | down a path based | complexity count) |
| | on meeting a | |
| | condition. | |
| CALL_NODE | call, call_indirect | Tracked for recursion depth |
| | (calls a function in | when target == caller |
| | a table with the | |
| | return_call_indirect | |
| | tail-call version as | |
| | well) | |
| EXIT_NODE | return, break, throw | Populates exit set during |
| | | loop body traversal |
| LITERAL_NODE | const, i32.const | Checked against loop |
| | | condition for |
| | | TRUE_LITERAL |
| | | detection |

The following pseudocode can be used to determine whether a LOOP_NODE is an infinite loop or the loop has a statically reachable exit path (STRUCTURAL_PATHOLOGY_FLAG=TRUE).

```
function build_exit_set(loop_node):
  exit_set = { }
  for each node in loop_node.body (depth-first):
  if node.type == EXIT_NODE:
      exit_set.add(node)
  if node.type == LOOP_NODE:
      skip subtree // nested loop boundary
  return exit_set
  if len(exit_set) == 0:
    STRUCTURAL_PATHOLOGY_FLAG = TRUE
```

For an encountered LOOP_NODE during AST traversal, parser 154 can perform a local exit set construction to determine whether the loop is an infinite loop and does not terminate.

A pseudocode to count encountered BRANCH_NODEs and SWITCH_NODEs can be as follows.

χ = 1
for each node in AST:
if node.type == BRANCH_NODE: χ += 1
if node.type == SWITCH_NODE: χ += (node.case_count − 1)
χ = min(χ, MSR_MAX_COMPLEXITY) // programmable hardware
register hard-cap to prevent counter overflow.

The counter starts at 1 (the base path) and increments by 1 for an encountered BRANCH_NODE. For a switch statement with K cases, the counter increments by K−1.

The following pseudocode can be used to determine a call stack depth from an encountered CALL_NODE.

δ = 0, call_stack = [ ]
for each CALL_NODE in AST:
if CALL_NODE.target in call_stack:
depth = call_stack.index(target) + 1
δ = max(δ, depth)
call_stack.push(CALL_NODE.target)

Maximum recursion depth (δ) tracks a call stack depth reached by self-referential CALL_NODEs and tracks the deepest recursion chain observed. A call is recursive if its target function identifier matches any ancestor in the current call stack. Each recursion increases complexity.

An example pseudocode to count EXIT_NODEs is as follows.

```
while (true) {
  if (x == magic_value( )) { break; } // EXIT_NODE present
  x = x + 1;
}
```

The loop is structurally distinct as there is a declared exit mechanism, even if that exit may be hard to trigger at runtime.

Another set of example scenarios and decisions of whether to admit the code segments for execution by processor 110 of host 102 is as follows.

| | | | | density | B_eff | |
|---|---|---|---|---|---|---|
| Scenario | N | χ | δ | (cyc/byte) | (cyc/byte) | Action |
| A (acceptable | 2,048 | 8 | 3 | 0.161 | 1.539 | ADMIT |
| code) | | | | | | |
| B (logic bomb) | 1,843 | 847 | 12 | 6.530 | 0.192 | REJECT |
| C (deep | 3,072 | 14 | 38 | 3.486 | 0.034 | REJECT |
| recursion) | | | | | | |
| D (signed | — | — | — | — | — | BYPASS |
| bypass) | | | | | | |
| E (infinite | 200 | 1 | 0 | 0.060 | 8.000 | REJECT |
| loop) | | | | | | |

For Scenario A, a valid payload is detected and admitted for execution by host processor 110. For example, a serverless function can include a 2 KB WASM HTTP request handler with moderate branching and no recursion. For example, parsing of AST can generate: χ=8 (5 if-branches+2 loop conditions+1 switch), δ=3 (outer function→loop→condition—no self-calls), N=2,048 bytes, and Pathology flag=FALSE (all loops have exit constructs). Calculation of C_cycles and B_effective can be as follows: branch term=1.0×8×12=96 cycles, recursion term=1.0×3\hat{ }1.5×45=1.0×5.196×45=234 cycles, C_cycles=96+234=330 cycles, density=330/2,048=0.161 cycles/byte, and B_effective=8.0/3\hat{ }1.5=8.0/5.196=1.539 cycles/byte. The code segment can be admitted for execution because its density is less than B_effective.

In scenario B, a payload includes a “logic bomb” and network interface device 150-0 rejects execution of the payload by host processor 110. For example, a 1.8 KB WASM module includes deeply nested conditionals inside a high-iteration loop. Despite a lightly loaded node, execution is denied based on density alone. An AST output parse can produce: χ=847 (combinatorial explosion from nested conditions inside loop), δ=12 (12 levels of nesting in loop body), N=1,843 bytes, and Pathology flag=FALSE as the loop has conditional exit but high cost density. Calculation of C_cycles and B_effective can be as follows: Branch term=1.0×847×12=10,164 cycles, recursion term=1.0×12\hat{ }1.5×45=1.0×41.569×45=1,871 cycles, C_cycles=10,164+1,871=12,035 cycles, density=12,035/1,843=6.530 cycles/byte, and B_effective=8.0/12\hat{ }1.5=8.0/41.569=0.192 cycles/byte. The code segment is rejected for execution because density is more than B_effective.

Scenario C can include a recursion attack that is detected and execution is rejected. An AST output parse can produce: χ=14 (moderate branching), δ=38 (38 levels of self-recursive calls), N=3,072 bytes, and Pathology flag=FALSE (recursion has base case and structural exit exists). Calculation of C_cycles and B_effective can be as follows: Branch term=1.0×14×12=168 cycles, recursion term=1.0×38\hat{ }1.5×45=1.0×234.21×45=10,539 cycles, C_cycles=168+10,539=10,707 cycles, the density=10,707/3,072=3.486 cycles/byte, and B_effective=8.0/38\hat{ }1.5=8.0/234.21=0.034 cycles/byte. The code segments can be rejected for execution by the host processor because density is greater than B_effective. Low χ makes the code segment appear benign on branching alone. However, the attack vector is δ=38 which indicates extreme recursion depth and causes exponential stack growth on the host.

Scenario D can permit host processor execution of a trusted signed payload. A firmware update from a manufacturing authority arrives carrying a valid RSA-4096 signature as Trusted_Signature_Present flag in header. Parser 154 verifies RSA-4096 signature against public key in hardware-rooted read only memory (ROM) (e.g., memory 130 or other memory). The trust bypass path routes code segments directly to privileged queue 132 without invoking AST parsing and no C_cycles are computed, density is not computed, B_effective is not computed, and pathology flag is not evaluated.

In Scenario E, a payload includes an infinite loop. A small 200-byte payload containing a true unconditional infinite loop. A parse of an AST output can generate: χ=1 (no branch nodes and single unconditional back-edge), δ=0 (no self-recursive calls), N=200 bytes, no EXIT_NODEs found in subtree, and Pathology flag=TRUE. Calculation of C_cycles and B_effective are: branch term=1.0×1×12=12 cycles, recursion term=1.0×0\hat{ }1.5×45=0 cycles, C_cycles=12+0=12 cycles, density=12/200=0.060 cycles/byte, B_effective=B_base=8.0 cycles/byte. Parser 154 would admit code segments 162 for execution to processor 110 without pathology flag as calculations because density is less than B_effective however, STRUCTURAL_PATHOLOGY_FLAG=TRUE, which overrides forwarding to host processor 110.

In some examples, the network interface device receives, in or with the packet, an optional priority signal or fee (F) associated with code segment 162, where F indicates the relative computational value the sender attaches to executing the code segment. Parser 154 can determine whether to permit host processor 110 to execute code segments 162 based on a F determined by resource cost estimation 156 and complexity (Omega) score. For example, if Fee>k*Omega, then the complexity and resource utilization of the code segments 162 is a level that host processor 110 is to execute code segments 162. For example, if Fee<k*Omega, then the complexity and resource utilization of code segments 162 is a level that host is to not execute code segments 162.

Based on denial of execution of code segments 162, device 150-0 can request sender to resend code with nonce or indicator that indicates code is to be trusted and executed by host processor 110 or inform sender that the code segments 162 were not executed. The nonce can be verified against a value previously provisioned to device 150-0 by an authorized control plane (e.g., SDN controller 450 or MCC 430) such that the nonce cannot be formed by a sender network interface device.

If device 150-0 permits host processor 110 to execute code segments 162, sequencer 120 can fill queue 132 with the highest density transactions first to complete higher density transactions sooner. Sequencer 120 can order admitted payloads by Efficiency Density D=Fee/Ω, where Ω is the structural complexity score derived from AST, prioritizing payloads with higher computational value density for host execution in environments where an optional fee or priority signal is attached to the payload. Sequencer 120 can use Ω, or an Efficiency Density D=F/Ω, to order admitted code segments in queue 132. In some examples, sequencer 120 can prioritize lean code (e.g., code with lower resource cost to execute), to increase throughput of hardware and reduce head of line blocking. Lean code can include code segments having higher Efficiency Density D=F/Ω, where F is an optional fee or priority signal carried in or with the packet and Ω is the composite structural complexity score derived from the AST.

A packet may be used herein to refer to various formatted collections of bits that may be sent across a network, such as Ethernet frames, Internet Protocol (IP) packets (e.g., IPv4 or IPv6), Transmission Control Protocol (TCP) segments, User Datagram Protocol (UDP) datagrams, etc. A flow can be a sequence of packets being transferred between two endpoints, generally representing a single session using a protocol. Accordingly, a flow can be identified by a set of defined tuples and, for routing purpose, a flow is identified by the two tuples that identify the endpoints, i.e., the source and destination addresses. For content-based services (e.g., load balancer, firewall, Intrusion detection system etc.), flows can be identified at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique queue pair (QP) number or identifier.

While examples are described with respect to execution of executable code segments 162 by host processor 110, in addition, or alternatively, a processor of network interface device 150-0 can execute code segments 162.

Various example usage environments are described next. A cloud gateway can accept or reject serverless functions based on static complexity analysis before instantiating a container. This prevents wallet exhaustion attacks in cloud billing, where attackers force the cloud provider to spin up expensive resources for junk code.

An industrial controller's network interface device can validate incoming logic updates (e.g., programmable logic controller (PLC) code) against a complexity threshold, to reject execution of updates with a complexity threshold indicative of a malicious or buggy update from causing a controller timing violation or crash in critical infrastructure.

An application (e.g., a browser or game engine) can offload structural validation of third-party plugins (e.g., extensions/mods) to a network interface device. This ensures the main application thread is never blocked or crashed by poorly written external code.

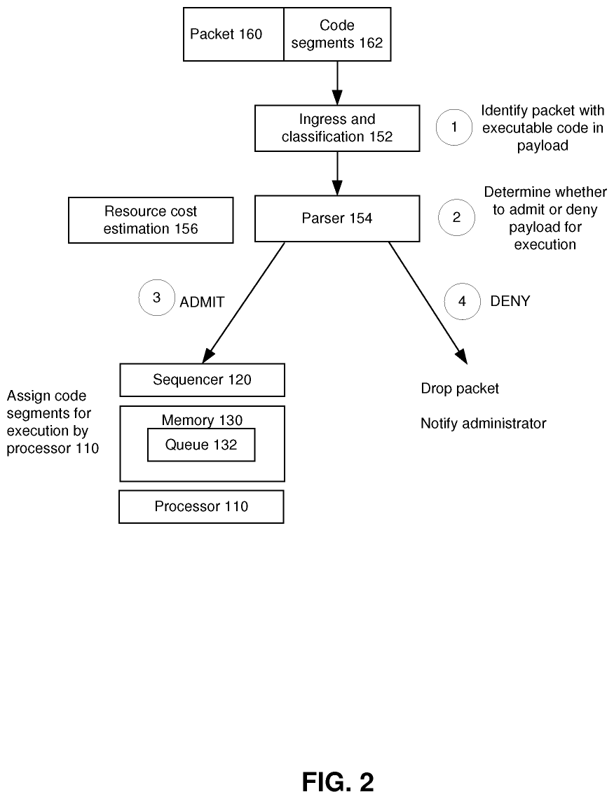

FIG. 2 depicts example operations to determine whether to permit or deny performance of workloads by a host processor. At (1), based on receipt of packet 160, ingress and classification 152 can determine whether a payload of packet 160 includes executable code segments 162. Based on ingress and classification 152 determining that packet 160 does not include executable code segments 162, packet 160 can be allocated for protocol processing and storage of data into memory 130. At (2), based on identification of executable code segments 162, parser 154 can process code segments 162 to determine whether to admit or deny executable code segments 162 to execution by processor 110. Admission or denial of execution of code segments 162 by processor 110 can be based on an indicator (e.g., nonce) in packet 160 indicating to execute the code segments, code execution complexity (e.g., structural complexity score), efficiency density, resource cost, or other indicators. For example, parser 154 can represent code segments 162 as a tree to determine a level of nesting or branching of the code.

Based on a determination to provide code segments 162 for execution by processor 110, at (3), sequencer 120 of host system can determine a priority or placement of code segments 162 in queue 132. Sequencer 120 can fill queue 132 with the highest density transactions first to execute higher density transactions sooner. In some examples, sequencer 120 can utilize Knapsack Optimization to assign workloads to positions in queue 132.

At (4), based on parser 154 determining that executable code segments 162 are to utilize resources of processor 110 or other resources (e.g., memory, accelerator, or others) in a manner that is likely an attack, packet 160 can be dropped and an administrator informed of a potential attack from a sender of the packet.

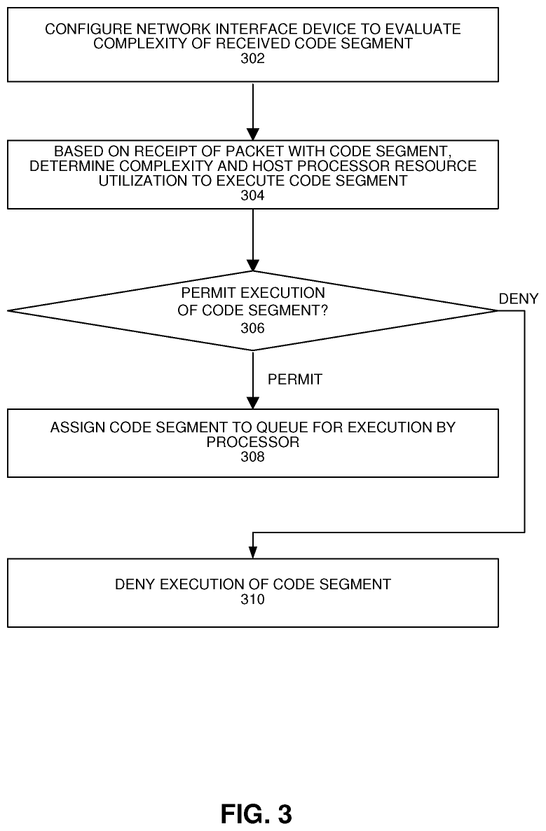

FIG. 3 depicts an example process for pre-execution validation of a payload at a programmable network interface device. At 302, the programmable network interface device can be configured to analyze payloads of received packets to determine whether a host processor is to execute code segments in the payloads or deny execution of the code segments. Programmable network interface device can include a network interface device positioned in the packet path between network ingress and a host operating system and the host processor can include a general-purpose processor (e.g., CPU or other processor). At 304, based on receipt of a packet with a code segment at the programmable network interface device, the network interface device can determine a density, complexity, resource cost of executing the code segments, or other factors. For example, the network interface device can parse the payload into an Abstract Syntax Tree (AST), but not execute the payload, and compute a resource cost vector from the AST topology using integer arithmetic. Computing the resource cost vector can include computing a composite structural complexity score and translating the complexity score into hardware-native units by multiplying the complexity score by programmable per-operation cycle cost constants stored in device registers. The complexity score can be determined based on Ω=α·χ+β·δ, where χ is cyclomatic complexity, δ is recursion depth, and α and β are policy coefficients. Resource cost vector can represent estimated CPU cycles, estimated power consumption, and estimated memory utilization on a target host processor.

At 306, the network interface device can admit or deny execution of code segments of the payload by a host processor. The network interface device can admit the code segments of the payload to the host processor based on the projected resource cost vector being within available system headroom. The network interface device can admit the payload to the host processor based on the payload being received with a nonce or other indicator that the payload is to be executed by the host processor irrespective of the complexity and cost, density, and complexity calculations can be bypassed. The network interface device can reject the payload from execution by the host processor without interrupting the host processor when the projected resource cost vector exceeds available system headroom.

At 308, based on a determination to admit the code segments of the payload to the host processor, the network interface device can assign the code segments to a position in a queue for execution by a host processor, accelerator, or other circuitry. For example, a position in the queue can be based on a complexity of the code segments so that lower complexity code segments are executed before higher complexity code segments, higher complexity code segments are executed before lower complexity code segments, a priority of execution of the code segments indicated in the packet that transmitted the code segments, or other factors.

At 310, based on a determination to deny the code segments of the payload from execution by the host processor, the network interface device can drop the packet, inform a network administrator or orchestrator, and/or inform a sender of the packet that code in the received packet was rejected for execution.

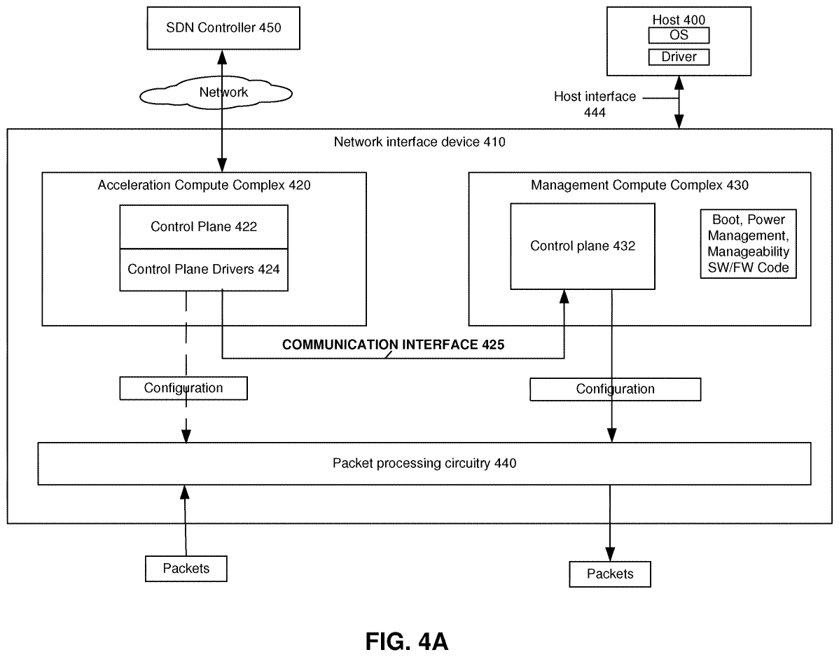

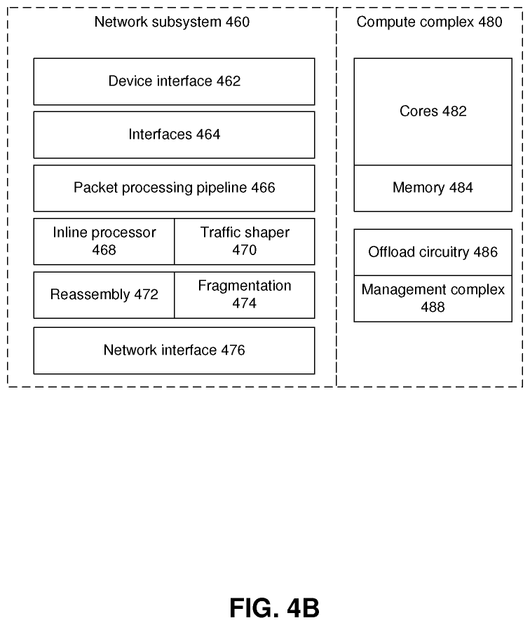

FIG. 4A depicts an example system. Host 400 can include processors, memory devices, device interfaces, as well as other circuitry described herein. Processors of host 400 can execute software such as processes (e.g., applications, microservices, virtual machine (VMs), microVMs, containers, processes, threads, or other virtualized execution environments), operating system (OS), and device drivers. An OS or device driver can configure network interface device or packet processing device 410 to validate code segments in received packets to admit or deny the code segments for execution by a processor of host 400, as described herein. Host 400 can be coupled to network interface device 410 via a host or device interface.

Network interface device 410 can include multiple compute complexes, such as an Acceleration Compute Complex (ACC) 420 and Management Compute Complex (MCC) 430, as well as packet processing circuitry 440 and network interface technologies for communication with other devices via a network. ACC 420 can be implemented as one or more of: a microprocessor, processor, accelerator, field programmable gate array (FPGA), application specific integrated circuit (ASIC) or circuitry described herein. Similarly, MCC 430 can be implemented as one or more of: a microprocessor, processor, accelerator, field programmable gate array (FPGA), application specific integrated circuit (ASIC) or circuitry described herein. In some examples, ACC 420 and MCC 430 can be implemented as separate cores in a CPU, different cores in different CPUs, different processors in a same integrated circuit, different processors in different integrated circuit.

Network interface device 410 can be implemented as one or more of: a microprocessor, processor, accelerator, field programmable gate array (FPGA), application specific integrated circuit (ASIC) or circuitry described herein. Packet processing pipeline circuitry 440 can process packets as directed or configured by one or more control planes executed by multiple compute complexes. In some examples, ACC 420 and MCC 430 can execute respective control planes 422 and 432.

SDN controller 450 can upgrade or reconfigure software executing on ACC 420 (e.g., control plane 422 and/or control plane 432) through contents of packets received through packet processing device 410. In some examples, ACC 420 can execute control plane operating system (OS) (e.g., Linux) and/or a control plane application 422 (e.g., user space or kernel modules) used by SDN controller 450 to configure operation of packet processing pipeline 440. Control plane application 422 can incude Generic Flow Tables (GFT), ESXi, NSX, Kubernetes control plane software, application software for managing crypto configurations, Programming Protocol-independent Packet Processors (P4) runtime daemon, target specific daemon, Container Storage Interface (CSI) agents, or remote direct memory access (RDMA) configuration agents.

In some examples, SDN controller 450 can communicate with ACC 420 using a remote procedure call (RPC) such as Google remote procedure call (gRPC) or other service and ACC 420 can convert the request to target specific protocol buffer (protobuf) request to MCC 430. gRPC is a remote procedure call solution based on data packets sent between a client and a server. Although gRPC is an example, other communication schemes can be used such as, but not limited to, Java Remote Method Invocation, Modula-3, RPyC, Distributed Ruby, Erlang, Elixir, Action Message Format, Remote Function Call, Open Network Computing RPC, JSON-RPC, and so forth.

In some examples, SDN controller 450 can provide packet processing rules for performance by ACC 420. For example, ACC 420 can program table rules (e.g., header field match and corresponding action) applied by packet processing pipeline circuitry 440 based on change in policy and changes in VMs, containers, microservices, applications, or other processes. ACC 420 can be configured to provide network policy as flow cache rules into a table to configure operation of packet processing pipeline 440. For example, the ACC-executed control plane application 422 can configure rule tables applied by packet processing pipeline circuitry 440 with rules to define a traffic destination based on packet type and content. ACC 420 can program table rules (e.g., match-action) into memory accessible to packet processing pipeline circuitry 440 based on change in policy and changes in VMs.

For example, ACC 420 can execute a virtual switch such as vSwitch or Open vSwitch (OVS), Stratum, or Vector Packet Processing (VPP) that provides communications between virtual machines executed by host 400 or with other devices connected to a network. For example, ACC 420 can configure packet processing pipeline circuitry 440 as to which VM is to receive traffic and what kind of traffic a VM can transmit. For example, packet processing pipeline circuitry 440 can execute a virtual switch such as vSwitch or Open vSwitch that provides communications between virtual machines executed by host 400 and packet processing device 410.

MCC 430 can execute a host management control plane, global resource manager, and perform hardware registers configuration. Control plane 432 executed by MCC 430 can perform provisioning and configuration of packet processing circuitry 440. For example, a VM executing on host 400 can utilize packet processing device 410 to receive or transmit packet traffic. MCC 430 can execute boot, power, management, and manageability software (SW) or firmware (FW) code to boot and initialize the packet processing device 410, manage the device power consumption, provide connectivity to a management controller (e.g., Baseboard Management Controller (BMC)), and other operations.

One or both control planes of ACC 420 and MCC 430 can define traffic routing table content and network topology applied by packet processing circuitry 440 to select a path of a packet in a network to a next hop or to a destination network-connected device. For example, a VM executing on host 400 can utilize packet processing device 410 to receive or transmit packet traffic.

ACC 420 can execute control plane drivers to communicate with MCC 430. At least to provide a configuration and provisioning interface between control planes 422 and 432, communication interface 425 can provide control-plane-to-control plane communications. Control plane 432 can perform a gatekeeper operation for configuration of shared resources. For example, via communication interface 425, ACC control plane 422 can communicate with control plane 432 to perform one or more of: determine hardware capabilities, access the data plane configuration, reserve hardware resources and configuration, communications between ACC and MCC through interrupts or polling, subscription to receive hardware events, perform indirect hardware registers read write for debuggability, flash and physical layer interface (PHY) configuration, or perform system provisioning for different deployments of network interface device such as: storage node, tenant hosting node, microservices backend, compute node, or others.

Communication interface 425 can be utilized by a negotiation protocol and configuration protocol running between ACC control plane 422 and MCC control plane 432. Communication interface 425 can include a general purpose mailbox for different operations performed by packet processing circuitry 440. Examples of operations of packet processing circuitry 440 include issuance of non-volatile memory express (NVMe) reads or writes, issuance of Non-volatile Memory Express over Fabrics (NVMe-oF™) reads or writes, lookaside crypto Engine (LCE) (e.g., compression or decompression), Address Translation Engine (ATE) (e.g., input output memory management unit (IOMMU) to provide virtual-to-physical address translation), encryption or decryption, configuration as a storage node, configuration as a tenant hosting node, configuration as a compute node, provide multiple different types of services between different Peripheral Component Interconnect Express (PCIe) end points, or others.

Communication interface 425 can include one or more mailboxes accessible as registers or memory addresses. For communications from control plane 422 to control plane 432, communications can be written to the one or more mailboxes by control plane drivers 424. For communications from control plane 432 to control plane 422, communications can be written to the one or more mailboxes. Communications written to mailboxes can include descriptors which include message opcode, message error, message parameters, and other information. Communications written to mailboxes can include defined format messages that convey data.

Communication interface 425 can provide communications based on writes or reads to particular memory addresses (e.g., dynamic random access memory (DRAM)), registers, other mailbox that is written-to and read-from to pass commands and data. To provide for secure communications between control planes 422 and 432, registers and memory addresses (and memory address translations) for communications can be available only to be written to or read from by control planes 422 and 432 or cloud service provider (CSP) software executing on ACC 420 and device vendor software, embedded software, or firmware executing on MCC 430. Communication interface 425 can support communications between multiple different compute complexes such as from host 400 to MCC 430, host 400 to ACC 420, MCC 430 to ACC 420, management controller to MCC 430, management controller to ACC 420, or management controller to host 400.

Packet processing circuitry 440 can be implemented using one or more of: application specific integrated circuit (ASIC), field programmable gate array (FPGA), processors executing software, or other circuitry. Control plane 422 and/or 432 can configure packet processing pipeline circuitry 440 or other processors to perform operations related to one or more of: storage access (e.g., NVMe or NVMe-oF reads or writes), lookaside crypto Engine (LCE), Address Translation Engine (ATE), local area network (LAN), remote direct memory access (RDMA), compression/decompression, encryption/decryption, or other accelerated operations.

FIG. 4B depicts an example network interface device system. Various examples of packet processing device or network interface device 410 can utilize examples of circuitry and software described herein. In some examples, packet processing device or network interface device can include one or more of: a network interface controller (NIC), a remote direct memory access (RDMA)-enabled NIC, SmartNIC, router, switch, forwarding element, infrastructure processing unit (IPU), or data processing unit (DPU). Network subsystem 460 can be communicatively coupled to compute complex 480. Device interface 462 can provide an interface to communicate with a host. Various examples of device interface 462 can utilize protocols based on Peripheral Component Interconnect Express (PCIe), Compute Express Link (CXL), or others as well as virtual device interface such as virtual device interfaces.

Peripheral Component Interconnect express (PCIe) is described at least in Peripheral Component Interconnect (PCI) Express Base Specification 1.0 (2002), as well as earlier versions, later versions, and variations thereof. Compute Express Link (CXL) is described at least in Compute Express Link Specification version 1.0 (2019), as well as earlier versions, later versions, and variations thereof.

Interfaces 464 can initiate and terminate at least offloaded remote direct memory access (RDMA) operations, Non-volatile memory express (NVMe) reads or writes operations, and LAN operations. Packet processing pipeline 466 can perform packet processing (e.g., packet header and/or packet payload) based on a configuration and support quality of service (QoS) and telemetry reporting. Inline processor 468 can perform offloaded encryption or decryption of packet communications (e.g., Internet Protocol Security (IPSec) or others). Traffic shaper 470 can schedule transmission of communications. As described herein, fragmentation circuitry 474 can be configured by reassembly circuitry 472 or cores 482 to adjust an MTU of transmitted packets. Network interface 476 can provide an interface at least to an Ethernet network by media access control (MAC) and serializer/de-serializer (Serdes) operations.

Cores 482 can be configured to perform infrastructure operations such as storage initiator, Transport Layer Security (TLS) proxy, virtual switch (e.g., vSwitch), or other operations. Memory 484 can store applications and data to be performed or processed. Offload circuitry 486 can perform at least cryptographic and compression operations for host or use by compute complex 480. Offload circuitry 486 can include one or more graphics processing units (GPUs) that can access memory 484. Management complex 488 can perform secure boot, life cycle management and management of network subsystem 460 and/or compute complex 480.

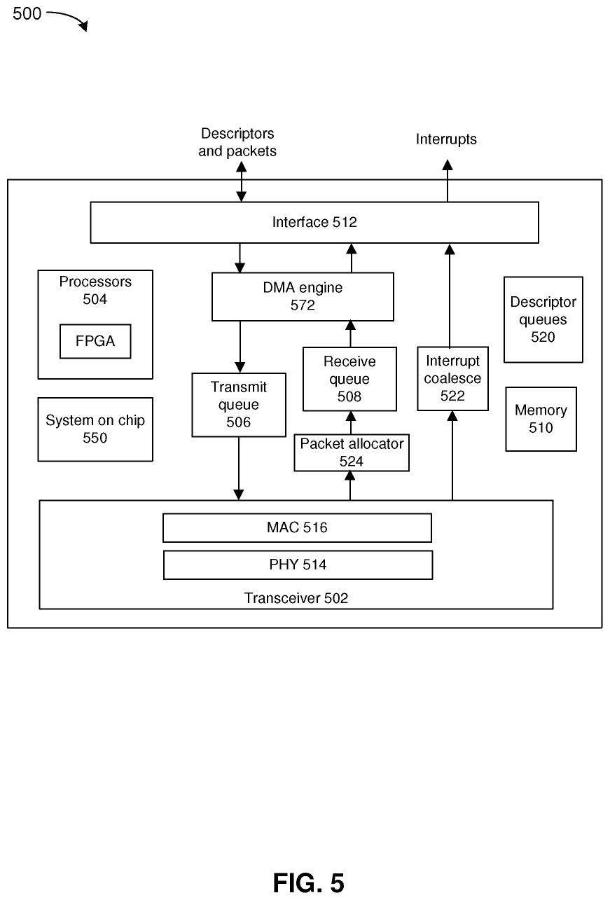

FIG. 5 depicts an example network interface device or packet processing device. Processors 504 or other circuitry can be used to validate code segments in received packets to admit or deny the code segments for execution by a host processor, as described herein. In some examples, packet processing device 500 can be implemented as a network interface controller, network interface card, a host fabric interface (HFI), or host bus adapter (HBA), and such examples can be interchangeable. Packet processing device 500 can be coupled to one or more servers using a bus, PCIe, CXL, or Double Data Rate (DDR). Packet processing device 500 may be embodied as part of a system-on-a-chip (SoC) that includes one or more processors, or included on a multichip package that also contains one or more processors.

Some examples of packet processing device 500 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Network interface 500 can include transceiver 502, processors 504, transmit queue 506, receive queue 508, memory 510, and host interface 512, and DMA engine 552. Transceiver 502 can be capable of receiving and transmitting packets in conformance with the applicable protocols such as Ethernet as described in IEEE 802.3, although other protocols may be used. Transceiver 502 can receive and transmit packets from and to a network via a network medium (not depicted). Transceiver 502 can include PHY circuitry 514 and media access control (MAC) circuitry 516. PHY circuitry 514 can include encoding and decoding circuitry (not shown) to encode and decode data packets according to applicable physical layer specifications or standards. MAC circuitry 516 can be configured to assemble data to be transmitted into packets, that include destination and source addresses along with network control information and error detection hash values.

System on chip (SoC) 550 and processors 504 can include any a combination of: processor, core, graphics processing unit (GPU), field programmable gate array (FPGA), application specific integrated circuit (ASIC), or other programmable hardware device that allow programming of network interface 500. For example, a “smart network interface” can provide packet processing capabilities in the network interface using processors 504.

Processors 504 can include one or more packet processing pipeline that can be configured to perform match-action on received packets to identify packet processing rules and next hops using information stored in a ternary content-addressable memory (TCAM) tables or exact match tables in some embodiments. For example, match-action tables or circuitry can be used whereby a hash of a portion of a packet is used as an index to find an entry. Packet processing pipelines can perform one or more of: packet parsing (parser), exact match-action (e.g., small exact match (SEM) engine or a large exact match (LEM)), wildcard match-action (WCM), longest prefix match block (LPM), a hash block (e.g., receive side scaling (RSS)), a packet modifier (modifier), or traffic manager (e.g., transmit rate metering or shaping). For example, packet processing pipelines can implement access control list (ACL) or packet drops due to queue overflow.

Configuration of operation of processors 504, including its data plane, can be programmed based on one or more of. Protocol-independent Packet Processors (P4), Software for Open Networking in the Cloud (SONiC), Broadcom® Network Programming Language (NPL), NVIDIA® CUDA®, NVIDIA® DOCA™, Infrastructure Programmer Development Kit (IPDK), among others.

Packet allocator 524 can provide distribution of received packets for processing by multiple CPUs or cores using timeslot allocation or receive side scaling (RSS). When packet allocator 524 uses RSS, packet allocator 524 can calculate a hash or make another determination based on contents of a received packet to determine which CPU or core is to process a packet.

Interrupt coalesce 522 can perform interrupt moderation whereby network interface interrupt coalesce 522 waits for multiple packets to arrive, or for a time-out to expire, before generating an interrupt to host system to process received packet(s). Receive Segment Coalescing (RSC) can be performed by network interface 500 whereby portions of incoming packets are combined into segments of a packet. Network interface 500 provides this coalesced packet to an application.

Direct memory access (DMA) engine 552 can copy a packet header, packet payload, and/or descriptor directly from host memory to the network interface or vice versa, instead of copying the packet to an intermediate buffer at the host and then using another copy operation from the intermediate buffer to the destination buffer.

Memory 510 can be any type of volatile or non-volatile memory device and can store any queue or instructions used to program network interface 500. Transmit queue 506 can include data or references to data for transmission by network interface. Receive queue 508 can include data or references to data that was received by network interface from a network. Descriptor queues 520 can include descriptors that reference data or packets in transmit queue 506 or receive queue 508. Host interface 512 can provide an interface with host device (not depicted). For example, host interface 512 can be compatible with PCI, PCI Express, PCI-x, Serial ATA, and/or USB compatible interface (although other interconnection standards may be used). In some examples, memory 510 can be off chip from other circuitry and accessible via an interface.

FIG. 6 depicts a system. In some examples, network interface device 650 can be configured to validate code segments in received packets to admit or deny the code segments for execution by processor 610 or other circuitry, as described herein. System 600 includes processor 610, which provides processing, operation management, and execution of instructions for system 600. Processor 610 can include any type of microprocessor, central processing unit (CPU), graphics processing unit (GPU), XPU, processing core, or other processing hardware to provide processing for system 600, or a combination of processors. An XPU can include one or more of: a CPU, a graphics processing unit (GPU), general purpose GPU (GPGPU), and/or other processing units (e.g., accelerators or programmable or fixed function FPGAs). Processor 610 controls the overall operation of system 600, and can be or include, one or more programmable general-purpose or special-purpose microprocessors, digital signal processors (DSPs), programmable controllers, application specific integrated circuits (ASICs), programmable logic devices (PLDs), or the like, or a combination of such devices. Processor 610 can include multiple processors and multiple processors can be embodied as processor sockets.

In one example, system 600 includes interface 612 coupled to processor 610, which can represent a higher speed interface or a high throughput interface for system components, such as memory subsystem 620 or graphics interface components 640, or accelerators 642. Interface 612 represents an interface circuit, which can be a standalone component or integrated onto a processor die. Where present, graphics interface 640 interfaces to graphics components for providing a visual display to a user of system 600. In one example, graphics interface 640 generates a display based on data stored in memory 630 or based on operations executed by processor 610 or both. In one example, graphics interface 640 generates a display based on data stored in memory 630 or based on operations executed by processor 610 or both.

Accelerators 642 can be a programmable or fixed function offload engine that can be accessed or used by a processor 610. For example, an accelerator among accelerators 642 can provide data compression (DC) capability, cryptography services such as public key encryption (PKE), cipher, hash/authentication capabilities, decryption, or other capabilities or services. In some cases, accelerators 642 can be integrated into a CPU socket (e.g., a connector to a motherboard or circuit board that includes a CPU and provides an electrical interface with the CPU). For example, accelerators 642 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 642 can provide multiple neural networks, CPUs, processor cores, general purpose graphics processing units, or graphics processing units can be made available for use by artificial intelligence (AI) or machine learning (ML) models. For example, the artificial intelligence (AI) model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 620 represents the main memory of system 600 and provides storage for code to be executed by processor 610, or data values to be used in executing a routine. Memory subsystem 620 can include one or more memory devices 630 such as read-only memory (ROM), flash memory, one or more varieties of random access memory (RAM) such as DRAM, or other memory devices, or a combination of such devices. Memory 630 stores and hosts, among other things, operating system (OS) 632 to provide a software platform for execution of instructions in system 600. Additionally, applications 634 can execute on the software platform of OS 632 from memory 630. Applications 634 represent programs that have their own operational logic to perform execution of one or more functions. Processes 636 represent agents or routines that provide auxiliary functions to OS 632 or one or more applications 634 or a combination. OS 632, applications 634, and processes 636 provide software logic to provide functions for system 600. In one example, memory subsystem 620 includes memory controller 622, which is a memory controller to generate and issue commands to memory 630. It will be understood that memory controller 622 could be a physical part of processor 610 or a physical part of interface 612. For example, memory controller 622 can be an integrated memory controller, integrated onto a circuit with processor 610.

Applications 634 and/or processes 636 can refer instead or additionally to a virtual machine (VM), container (e.g., Docker container), microservice, processor, or other software. Various examples can perform an application composed of microservices, where a microservice runs in its own process and communicates using protocols (e.g., application programming interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 632 can be Linux®, FreeBSD, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, AMD®, Qualcomm®, IBM®, Nvidia®, Broadcom®, Texas Instruments®, among others.

Configuration of network interface device 650 can be consistent with versions of Network Driver Interface Specification (NDIS), Network Adapter Class Extension (NetAdapterCx), or others. For example, network interface device 650 can advertise capabilities to validate code segments in received packets to admit or deny the code segments for execution by processor 610 or other circuitry, as described herein. OS 632 or a driver can enable or disable the capabilities by calling an API.

While not specifically illustrated, it will be understood that system 600 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 600 includes interface 614, which can be coupled to interface 612. In one example, interface 614 represents an interface circuit, which can include standalone components and integrated circuitry. In one example, multiple user interface components or peripheral components, or both, couple to interface 614. Network interface 650 provides system 600 the ability to communicate with remote devices (e.g., servers, workstations, or other computing devices) over one or more networks. Network interface 650 can include an Ethernet adapter, wireless interconnection components, cellular network interconnection components, USB (universal serial bus), or other wired or wireless standards-based or proprietary interfaces. Network interface 650 can transmit data to a device that is in the same data center or rack or a remote device, which can include sending data stored in memory. Network interface 650 can receive data from a remote device, which can include storing received data into memory. In some examples, packet processing device or network interface device 650 can refer to one or more of: a network interface controller (NIC), a remote direct memory access (RDMA)-enabled NIC, SmartNIC, router, switch, forwarding element, infrastructure processing unit (IPU), or data processing unit (DPU). An example IPU or DPU is described herein.

In one example, system 600 includes one or more input/output (I/O) interface(s) 660. I/O interface 660 can include one or more interface components through which a user interacts with system 600. Peripheral interface 670 can include any hardware interface not specifically mentioned above. Peripherals refer generally to devices that connect dependently to system 600.

In one example, system 600 includes storage subsystem 680 to store data in a nonvolatile manner. In one example, in certain system implementations, at least certain components of storage 680 can overlap with components of memory subsystem 620. Storage subsystem 680 includes storage device(s) 684, which can be or include any conventional medium for storing large amounts of data in a nonvolatile manner, such as one or more magnetic, solid state, or optical based disks, or a combination. Storage 684 holds code or instructions and data 686 in a persistent state (e.g., the value is retained despite interruption of power to system 600). Storage 684 can be generically considered to be a “memory,” although memory 630 is typically the executing or operating memory to provide instructions to processor 610. Whereas storage 684 is nonvolatile, memory 630 can include volatile memory (e.g., the value or state of the data is indeterminate if power is interrupted to system 600). In one example, storage subsystem 680 includes controller 682 to interface with storage 684. In one example controller 682 is a physical part of interface 614 or processor 610 or can include circuits or logic in both processor 610 and interface 614.

A volatile memory can include memory whose state (and therefore the data stored in it) is indeterminate if power is interrupted to the device. A non-volatile memory (NVM) device can include a memory whose state is determinate even if power is interrupted to the device.

In some examples, system 600 can be implemented using interconnected compute platforms of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications. Die-to-die communications can utilize Embedded Multi-Die Interconnect Bridge (EMIB) or an interposer. Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: an SoC, one or more tiles, or other circuitry.

In an example, system 600 can be implemented using interconnected compute platforms of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”

Illustrative examples of the devices, systems, and methods disclosed herein are provided below. An embodiment of the devices, systems, and methods may include any one or more, and any combination of, the examples described below.
Example 1 includes one or more later examples and includes an apparatus that includes a network interface device comprising: a host interface; a network interface; a direct memory access (DMA) circuitry; and circuitry to: receive a packet comprising code segments and permit execution of the code segments by a processor of a host system based on complexity of the code segments or deny execution of the code segments by the processor of the host system based on the complexity of the code segments.
Example 2 includes one or more later or earlier examples, wherein the circuitry is to permit or deny execution of the code segments by the processor of the host system based also on resource utilization to execute the code segments.
Example 3 includes one or more later or earlier examples, wherein the resource utilization to execute the code segments is based on one or more of: (i) estimated processor cycles to execute the code segments on the processor of the host system; (ii) estimated power consumption to execute the code segments; or (iii) estimated memory utilization to execute the code segments.
Example 4 includes one or more later or earlier examples, wherein: the circuitry is to determine that code segments comprise a Computational Denial of Service (cDoS) attack and deny execution of the code segments based on the complexity of the code segments and resource utilization to execute the code segments.
Example 5 includes one or more later or earlier examples, wherein: the circuitry is to permit execution of the code segments based on the packet carrying a valid cryptographic signature from an allowlisted authority and bypass determination of complexity and resource utilization of the code segments.
Example 6 includes one or more later or earlier examples, wherein: the circuitry is to deny execution of the code segments based on the code segments including a loop with no reachable exit construct irrespective of resource utilization.
Example 7 includes one or more later or earlier examples, wherein: based on denial of execution of the code segments by the processor of the host system, the circuitry is to inform a sender of the code segments that the code segments were denied execution.
Example 8 includes one or more later or earlier examples, and includes at least one non-transitory computer-readable medium comprising instructions stored thereon, that if executed by one or more processors, cause the one or more processors to: configure a network interface device to: indicate a capability to validate code segments in a received packet to admit or deny the code segments for execution by a processor of a host system and based on a request to perform the capability, enable the capability in the network interface device, wherein: based on enablement of the capability, the network interface device is to: permit execution of the code segments by the processor of the host system based on complexity of the code segments or deny execution of the code segments by the processor of the host system based the complexity of the code segments.
Example 9 includes one or more later or earlier examples, wherein: based on enablement of the capability, the network interface device is to permit or deny execution of the code segments by the processor of the host system based also on resource utilization to execute the code segments.
Example 10 includes one or more later or earlier examples, wherein the resource utilization to execute the code segments is based on one or more of: (i) estimated processor cycles to execute the code segments on the processor of the host system; (ii) estimated power consumption to execute the code segments; or (iii) estimated memory utilization to execute the code segments.
Example 11 includes one or more later or earlier examples, wherein based on enablement of the capability, the network interface device is to determine that code segments comprise a Computational Denial of Service (cDoS) attack and deny execution of the code segments that comprise the cDoS attack.
Example 12 includes one or more later or earlier examples, wherein based on enablement of the capability, the network interface device is to permit execution of the code segments based on the packet carrying a valid cryptographic signature from an allowlisted authority.
Example 13 includes one or more later or earlier examples, wherein based on enablement of the capability, the network interface device is to cause a sender of the code segments to re-transmit the code segments with an indicator that the re-transmitted code segments are to be trusted and are to be executed by the processor of the host system.
Example 14 includes one or more later or earlier examples, wherein based on enablement of the capability, the network interface device is to deny execution of the code segments based on the code segments including a loop with no reachable exit construct.
Example 15 includes one or more later or earlier examples, and includes a method comprising: a host system processor executing code segments received in a packet by a network interface device based on the network interface device permitting or denying execution of the code segments by the host system processor based on levels of complexity of the code segments.
Example 16 includes one or more later or earlier examples, and includes the network interface device permitting or denying execution of the code segments by the processor of the host system based also on resource utilization to execute the code segments.
Example 17 includes one or more later or earlier examples, wherein the resource utilization to execute the code segments is based on one or more of: (i) estimated processor cycles to execute the code segments on the processor of the host system; (ii) estimated power consumption to execute the code segments; or (iii) estimated memory utilization to execute the code segments.
Example 18 includes one or more later or earlier examples, and includes the network interface device determining that code segments comprise a Computational Denial of Service (cDoS) attack and denying execution of the code segments comprising the cDoS attack.
Example 19 includes one or more later or earlier examples, and includes the network interface device permitting execution of the code segments based on the packet carrying a valid cryptographic signature from an allowlisted authority.
Example 20 includes one or more earlier examples, and includes the network interface device causing a sender of the code segments to re-transmit the code segments with an indicator that the re-transmitted code segments are to be trusted and are to be executed by the processor of the host system.

1. An apparatus:
a network interface device comprising:
a host interface;
a network interface;
a direct memory access (DMA) circuitry; and
circuitry to:
receive a packet comprising code segments and
permit execution of the code segments by a processor of a host system based on complexity of the code segments or
deny execution of the code segments by the processor of the host system based on the complexity of the code segments.

2. The apparatus of claim 1, wherein the circuitry is to permit or deny execution of the code segments by the processor of the host system based also on resource utilization to execute the code segments.

3. The apparatus of claim 2, wherein the resource utilization to execute the code segments is based on one or more of: (i) estimated processor cycles to execute the code segments on the processor of the host system; (ii) estimated power consumption to execute the code segments; or (iii) estimated memory utilization to execute the code segments.

4. The apparatus of claim 1, wherein:
the circuitry is to determine that code segments comprise a Computational Denial of Service (cDoS) attack and deny execution of the code segments based on the complexity of the code segments and resource utilization to execute the code segments.

5. The apparatus of claim 1, wherein:
the circuitry is to permit execution of the code segments based on the packet carrying a valid cryptographic signature from an allowlisted authority and bypass determination of complexity and resource utilization of the code segments.

6. The apparatus of claim 1, wherein:
the circuitry is to deny execution of the code segments based on the code segments including a loop with no reachable exit construct irrespective of resource utilization.

7. The apparatus of claim 1, wherein:
based on denial of execution of the code segments by the processor of the host system, the circuitry is to inform a sender of the code segments that the code segments were denied execution.

8. At least one non-transitory computer-readable medium comprising instructions stored thereon, that if executed by one or more processors, cause the one or more processors to:
configure a network interface device to:
indicate a capability to validate code segments in a received packet to admit or deny the code segments for execution by a processor of a host system and
based on a request to perform the capability, enable the capability in the network interface device, wherein:
based on enablement of the capability, the network interface device is to:
permit execution of the code segments by the processor of the host system based on complexity of the code segments or deny execution of the code segments by the processor of the host system based the complexity of the code segments.

9. The computer-readable medium of claim 8, wherein:
based on enablement of the capability, the network interface device is to permit or deny execution of the code segments by the processor of the host system based also on resource utilization to execute the code segments.

10. The computer-readable medium of claim 9, wherein the resource utilization to execute the code segments is based on one or more of: (i) estimated processor cycles to execute the code segments on the processor of the host system; (ii) estimated power consumption to execute the code segments; or (iii) estimated memory utilization to execute the code segments.

11. The computer-readable medium of claim 8, wherein based on enablement of the capability, the network interface device is to determine that code segments comprise a Computational Denial of Service (cDoS) attack and deny execution of the code segments that comprise the cDoS attack.

12. The computer-readable medium of claim 8, wherein based on enablement of the capability, the network interface device is to permit execution of the code segments based on the packet carrying a valid cryptographic signature from an allowlisted authority.

13. The computer-readable medium of claim 8, wherein based on enablement of the capability, the network interface device is to cause a sender of the code segments to re-transmit the code segments with an indicator that the re-transmitted code segments are to be trusted and are to be executed by the processor of the host system.

14. The computer-readable medium of claim 8, wherein based on enablement of the capability, the network interface device is to deny execution of the code segments based on the code segments including a loop with no reachable exit construct.

15. A method comprising:
a host system processor executing code segments received in a packet by a network interface device based on the network interface device permitting or denying execution of the code segments by the host system processor based on levels of complexity of the code segments.

16. The method of claim 15, comprising:
the network interface device permitting or denying execution of the code segments by the processor of the host system based also on resource utilization to execute the code segments.

17. The method of claim 16, wherein the resource utilization to execute the code segments is based on one or more of: (i) estimated processor cycles to execute the code segments on the processor of the host system; (ii) estimated power consumption to execute the code segments; or (iii) estimated memory utilization to execute the code segments.

18. The method of claim 15, comprising:
the network interface device determining that code segments comprise a Computational Denial of Service (cDoS) attack and denying execution of the code segments comprising the cDoS attack.

19. The method of claim 15, comprising:
the network interface device permitting execution of the code segments based on the packet carrying a valid cryptographic signature from an allowlisted authority.

20. The method of claim 15, comprising:
the network interface device causing a sender of the code segments to re-transmit the code segments with an indicator that the re-transmitted code segments are to be trusted and are to be executed by the processor of the host system.
